(19) United States
(12) Patent Application Publication
(10) Pub. No.: US 2014/0271433 A1
(43) Pub. Date: Sep. 18, 2014

(54) Method for Improving the Reaction Rate in Gas Hydrate Formation Processes

(71) Applicant: Berit Nuland, Strommen (NO)

(72) Inventors: Sven Nuland, Strommen (NO); Lan Liu, Skedsmokorset (NO); Martin Foss, Skedsmokorset (NO); Karin Hald, Oslo (NO)

(73) Assignee: INSTITUTT FOR ENERGITEKNIKK, Kjeller (NO)

(21) Appl. No.: 14/111,188

(22) PCT Filed: Apr. 16, 2012
(86) PCT No.: PCT/EP12/56944

§ 371 Date: Mar. 19, 2014

(30) Foreign Application Priority Data
Apr. 15, 2011 (NO) 20110602

(51) Int. Cl. B01D 53/62

(52) U.S. Cl. CPC B01D 53/62
USPC 423/220; 423/437.1

(57) ABSTRACT

A method for improving the reaction rate and better utilize the storage capacity of water in gas hydrate formation processes in which heterogeneous nucleation seeds in the form of mineral particles dispersed in the water phase are used.

The present invention concerns a method for improving the reaction rate and better utilize the storage capacity of water in gas hydrate formation processes.

### BACKGROUND

CO₂ has been confirmed to be a major agent of global warming. Capturing CO₂ before its release to the atmosphere, in particular from power plants and other processes releasing CO₂ gas, is a solution to reduce its emissions.

Norwegian Patent No. 321 097 teaches a method for cleaning water and gas by means of hydrate formation. Hydrate forming compound and nucleation seeds are used in combination with cooling and pressurizing. The nucleation seeds used are recycled seeds of hydrate particles formed earlier in the process, homogenous seeds, which grows successively for each recycle loop. Their size will therefore largely depend on the number of cycles they have been through and the particle size distribution of these seeds will typically vary within wide limits unless particular measures are taken to control the particle size. Increased risk for blockage of pipes, pumps and other equipment will also be expected unless measures to control/reduce particle size are taken

### OBJECTS OF THE PRESENT INVENTION

It is an object of the present invention to improve the reaction rate for gas hydrate formation processes, the primary use thereof being to improve carbon capture from flues gases and the like.

### SUMMARY OF THE INVENTION

The object is achieved by the method according to the present invention as defined by claim 1. Preferred embodiments of the invention are disclosed by the dependent claims. The word “mineral” as used herein should be interpreted in a broad sense, typically as opposed to “organic” and not only naturally occurring minerals.

This invention consists in a new and inventive process to capture CO₂ from a gas mix, at lower cost per ton CO₂ captured than alternative processes. One example of a typical gas mix is flue gas. The capture process utilizes a selective hydrate formation and growth process where CO₂ is concentrated from an N₂ phase. The method according to the present invention can be performed as a single step process, but it is preferred that it is performed with in at least two repetitive steps or cycles. During each cycle the seeds and promoter chemicals will be recycled and energy loss will be minimized through clever management of heat. Once separated, the CO₂ can be injected in underground reservoirs etc.

Whereas the invention has been an attempt at solving the CO₂ capture challenge, it can solve other challenges where gas can be separated from a gas mix thanks to selective affinity to hydrates formation.

### DETAILED DESCRIPTION OF THE INVENTION

In the following lines, a preferred embodiments, CO2 capture in a flue gas. The proposed process uses hydrates to separate CO₂ from the rest of the gases in the flue gas, mainly N₂. The process may include the use of two additives to improve the hydrate formation and lower the overall energy consumption of the process.

The core of the present invention is the addition of heterogeneous nucleation seeds, for instance titanium oxide particles or other light metal oxide particles (based on Al, Mg, Fe and Si complexes) such as mica, to speed up the hydrate formation process. Silicate particles are also preferred. The surface of the particle may be treated (or “preactivated”) to achieve a preferable hydrophilicity so as to accommodate nucleation of hydrate on the surface. This would typically involve hydration of the particles using processes such as normal ageing, prolonged contact with a normal humid atmosphere, or in an accelerated process involving the application of heat and steam. In addition to this the particles should be modified to obtain a size and morphology optimum for hydrate nucleation and growth. This can be achieved through crushing of the particles. These particles are referred to as seeds in the text below or in the figure as TiO. These nucleation particles also cause the hydrates to grow on the particles suspended inside the water droplets, preventing the formation of a hydrate crust around the droplets. The formation of an external crust will hinder the transport of gas to the nucleation site, and heat away from the site, so it is important to avoid this. This is commented in more detail in WO 2009 054733 A1 by same inventor.

The use of heterogeneous seeds allow us to optimize the size and surface properties of the particles, and be sure these properties survive a recycling and reuse of the particles. The particles should preferably be so small that they easily are mixed into the process water, e.g. with a size in the range 20-50 μm. Even smaller particles could be used but particles less than 0.1 μm will typically not be effective as hydrate nucleation seeds. Down to a certain size it is found that the effectiveness of the particles increases with reducing size, and it is therefore preferred to optimize the nucleation seed particles with regard to their size, to the smallest particles being effective with respect to hydrate formation. Small particles allow us to create many reactions centers and small distances from any place in the process water to a reaction center, without introducing a volume fraction of particles that may significantly change the rheology of the mixture. The advantages of using heterogeneous nucleation seeds as compared to recycled, homogeneous nucleation seeds are firstly that the size of the nucleation seeds are easily controlled and can be maintained within strict limits independent of the numbers of cycles used. Secondly the surface of the nucleation seed particles may, as mentioned above, be modified to make them particularly active with regard to the task of initiating hydrate formation.

It should be noted that the present invention will typically be carried out in combination with introduction of a “hydrate promoter” to reduce the pressure at which hydrates form. This would involve addition of a chemical that is known to lower the formation pressure for the desired hydrate. Suggested candidates are tetra butyl ammonium bromide (TBAB) or any chemical of similar function. For example there is a chloride (TBAC) that also promotes hydrate formation, but is less explored. Several other chemicals can also be used and will be identified through further research.

FIG. 1 shows a schematic drawing of the process to capture carbon using gas hydrates, a preferred embodiment of the invention. The temperatures and pressures indicated are approximate, and are indicated for the purpose of illustration, they are not limitative as to the scope of the invention. The concepts described above significantly lower the overall energy consumed and improves reaction rates in the processes.

Flue gas is entering the process, it is cooled, at [A] in the figure, and contaminants like NOx and SOx, may be removed. The process will probably function with these contaminants present as they will behave approximately as N₂. The initial cooling may be directly or indirectly be part of the heating in box [E] where the gas is released by melting the hydrates. Following [A] the gas mixture is compressed [B] and cooled [C] to 15 bar and 2° C. The gas is then introduced into a counter current gas/liquid contactor [D]; and mixed with cold water containing the chemicals and particles described above. The contactor may be a spray column or a bubble column, whatever is found to be most effective for the proposed process. The contactor is supplied with extra cooling to remove the heat of formation of the gas hydrates.

Most of the CO₂ and some N₂ are incorporated into the hydrate produced while the rest of the N₂ and a little CO₂ is vented to the atmosphere. The venting should be done through a turbo expander (or similar device), to regain some of the pressure energy of this gas (not shown explicitly).

The hydrate slurry is transported from [D] to a device [E] for releasing the gas through heating. Moderate temperature increase is needed, but the latent heat of fusion is high—similar to ice. If the amount of waste heat is insufficient for melting the hydrates and releasing the CO₂ gas, a heat pump between the hydrate formation vessel [D] and the hydrate dissociation In order to obtain a transportable slurry excess water is added after the hydrate formation is finished. Our experience is that particle volume fractions below 30% can be transported, while volume fractions above 40% tend to give trouble with blockages. This assumes that the flow rates are sufficient to keep the particles mixed into the flow through turbulent or induced mixing. vessel [E] could provide the heat in an economical way.

Before the slurry is heated to release the gas, this excess water is removed (centrifuged) without heating the slurry or reducing the pressure.

The water resulting from the hydrate dissociation still contain the hydrate promoter and the nucleation seeds, and can now be cooled to approximately 2° C. at [F] and recirculated to the gas/liquid contactor [D].

The gas mixture is compressed and cooled [G], and again contacted with cold water with hydrate promoter and seeds, hydrate is formed in another counter current gas/liquid contactor [H] and waste N₂ is vented to the atmosphere, possibly through a turbo expander.

The hydrate slurry is heated and melted at [J] and the purified CO₂ is released, for example for further compression and injection. The water with dissolved hydrate promoter and seeds is recirculated and cooled at [K].

The waste N₂ gas at D and H is expanded through a turboexpander to recover energy. The turbo expander consist of a number of stages with interheaters (opposite of intercooler) where hot gas is used to heat the expanded and cooled N2 gas to maximize the energy recovery. This hot gas could be flue gas or the “interheater” of the turbo expander could be combined with the intercoolers of the compressor B.

A particularly preferred embodiment of the present invention comprises the steps of:
I. -cooling a flue gas containing a gas component to be captured,
II. compressing the flue gas and cooling the compressed gas to obtain a gas with a pressure of about 15 bar and 2° C.,
III. contacting the gas with countercurrent flow of a liquid containing heterogeneous nucleation seeds to initiate hydrate formation,
IV. charging the liquid/hydrate slurry formed to a decanter step to dewater the slurry before evaporating the gas,
V. evaporating the gas to a confined volume for subsequent handling thereof,
VI. recycling liquid and hydrate nucleation seeds to step iii.

The number of stages depends on the inlet CO₂ concentration. With 15% CO₂ it has been calculated that two stages are enough, if the CO₂ is more diluted more stages may be needed.

A very rough estimate of this illustrated process indicates a power consumption range of 220-330 kW/ton CO₂ separated, whereas literature on CO₂ capture by the ammonia process seems to indicate a range of 470-550 kW/ton CO₂. This process may reduce energy consumption by half!

This description is based on the case of flue gas, nucleation seeds of the heterogeneous type, hydrate promoter of the TBAB type, and on an illustrative process description including two capture-dissociation cycles. However, it is the object of the invention to generally enable extraction of gas from a gas mix thanks to selective hydrate formation and dissociation, the hydrate process being possibly eased by the use of nucleation seeds and hydrate promoters. Gas concerned are thus gas which are of the type to form and grow hydrate particles, such as O₂, H₂, N₂, CO₂, CH₄, H₂S, Ar, Kr, and Xe, as well as some higher hydrocarbons and freons (list extracted from Wikipedia).

This invention is adapted to extract a gas typically having a higher affinity for hydrate formation than the other components of the gas mix. However, one may also use the invention to separate a gas which has lower affinity to hydrate formation than the other components of the gas mix, the final product being vented out after each hydrate formation cycle.

The “hydrates” term will be construed as describing hydrates or clathrates. The gas mix may be part of a multiphase mix, where the gas-liquid contactor described in our preferred embodiment may be replaced by state of the art contactor.

Another advantage of the method according to the present invention is the fact that the process operates at moderate temperatures and pressures, typically a pressure of about 15 bars and temperature in the range from 2-6° C. during hydrate formation and 30 to 40° C. during hydrate evaporation.

Agitation of the reaction mixture is not required, the required movement is obtained by the countercurrent flow of gas and liquid in the gas/liquid contactor D.

We claim:

1. A method for improving the reaction rate and better utilize the storage capacity of water in gas hydrate formation processes characterized by use of heterogeneous nucleation seeds in the form of mineral particles dispersed in the water phase.

2. A method according to claim 1 where the nucleation seeds are selected from the group consisting of light metal oxide particles.

3. A method according to claim 1 where the nucleation seeds are titanium oxide particles.

4. A method according to claim 1 where the nucleation seeds are mica particles.

5. A method according to claim 1 where the nucleation seeds are silicate particles.

6. A method according to claim 1, where the surface of the nucleation seeds is hydrated through contact with the natural atmosphere over time.

7. A method according to claim 1, where the surface of the nucleation particles is hydrated through an accelerated process by applying heat or steam.

8. A method according to claim 1, where the nucleation seeds have a rough surface to improve the hydrate formation initiation capability.

9. A method according to claim 1, where the particle size of the heterogeneous nucleation seeds is in the range 20-50 μm.

10. A method according to claim 1, where the heterogeneous nucleation seeds are optimized with regard to particle size to the smallest particles effective in hydrate formation.

11. A method according to any one of the preceding claims claim 1, including the sequential steps of:
VII. cooling a flue gas containing a gas component to be captured,
VIII. compressing the flue gas and cooling the compressed gas to obtain a gas with a pressure of about 15 bar and 2° C.,
IX. contacting the gas with countercurrent flow of a liquid containing heterogeneous nucleation seeds to initiate hydrate formation,
X. charging the liquid/hydrate slurry formed to a decanter step to dewater the slurry before evaporating the gas,
XI. evaporating the gas to a confined volume for subsequent handling thereof,
XII. recycling liquid and hydrate nucleation seeds to step iii.
